(19) United States
(12) Patent Application Publication
(10) Pub. No.: US 2026/0319922 A1
(43) Pub. Date: Oct. 15, 2026

(54) ERROR DIAGNOSTICS IN COMPLEX APPLICATIONS

(71) Applicant: International Business Machines Corporation, Armonk, NY (US)

(72) Inventors: Shailesh Chandra Jamloki, Noida (IN); Jitendra Kumar Panda, Bangalore (IN)

(21) Appl. No.: 19/174,023

(22) Filed: Apr. 9, 2025

(51) Int. Cl. G06F 11/362

(52) U.S. Cl. CPC G06F 11/366

(57) ABSTRACT

A computer-implemented method includes identifying an occurrence of an error within a complex application, wherein the complex application includes a plurality of internal components. Multiple operations logs are gathered into a log set with each operation log being generated by a corresponding one of the plurality of internal components. At least one of a format and a type of operation log is not uniform across the operation logs. The log set is applied to a data transformer. The data transformer is a software module configured to merge the operation logs into a merged log and identify relevant data of the merged log. Identified relevant data of the merged log is provided to a technician.

### BACKGROUND

The present invention generally relates to application diagnostics, and more specifically to a system and process for diagnosing errors in complex applications.

Complex software applications include many components operating simultaneously to achieve a particular function or operation. In enterprises different software applications and systems operate in coordination to work and perform one or more business functions. By way of example, a cloud software application may utilize and/or communicate with and through hundreds of component programs (components) to perform a given function. Each of those components generates a separate log documenting the operations performed by the component.

When an error occurs within the application, the logs are analyzed to determine a root cause of the error. The analysis is complicated by the fact that the various distinct components generate different types and formats of error logs, as well as the number of logs that may be relevant. Further complicating the analysis is the availability of diagnostic information generated by human software users (e.g. screenshots, textual descriptions of an error, etc.), and the fact that such data does not fit neatly within an error log.

### SUMMARY

Embodiments of the present invention are directed to a computer-implemented method for consolidating and analyzing error logs. A non-limiting example of the computer-implemented method includes consolidating and analyzing evidences. A non-limiting example computer-implemented method includes identifying an occurrence of an error within a complex application, wherein the complex application includes a plurality of internal components. Multiple operations logs are gathered into a log set with each operation log being generated by a corresponding one of the plurality of internal components. At least one of a format and a type of operation log is not uniform across the operation logs. The log set is applied to a data transformer. The data transformer is a software module configured to merge the operation logs into a merged log and identify relevant data of the merged log. Identified relevant data of the merged log is provided to a technician.

Embodiments of the invention are further directed to a computer program product for storing instructions to implement the computer-implemented method. The computer program product comprising a computer readable storage medium having program instructions embodied therewith. The program instructions are executable by a processor to cause the processor to perform a method.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts one exemplary cloud computing system configured to implement the system and method according to one embodiment;

FIG. 2 depicts a schematic representation of a complex application;

FIG. 3 depicts a process by which an error is reported to a technician; and

FIG. 4 depicts an example method for operating a data transformer used in the example of FIG. 3.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Computing environment 100 contains an example of an environment for the execution of at least some of the computer code involved in performing the inventive methods, such as providing error diagnostics in complex applications at block 150. In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public Cloud 105 includes gateway 140, Cloud orchestration module 141, host physical machine set 142, virtual machine set 143, and container set 144.

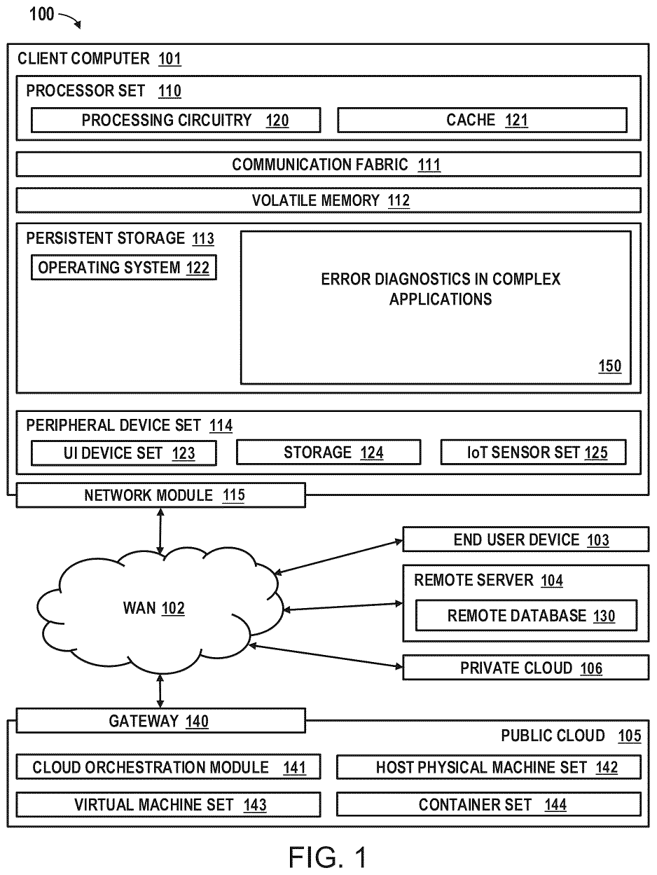

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 141. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Computer programs and applications, such as those utilized within cloud computing architectures have been historically contextualized as block box systems, where an input goes in, the system operates, and an output is generated. As the internal operations have increased in complexed, errors and other logs generated by the top level system provide less and less useful information for diagnosing and addressing root causes of errors.

In some configurations, the application may include multiple internal components (e.g. sub-applications) that provide specific functions and interact with the other components. Systems having such a configuration are referred to herein as “complex applications”.

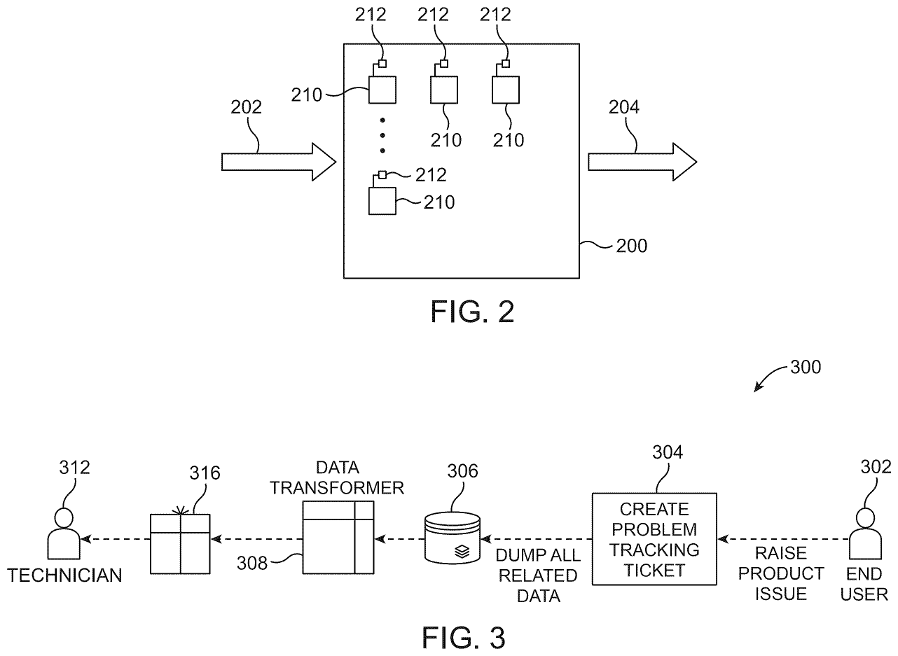

With continued reference to FIG. 1, FIG. 2 provides a highly schematic representation of a complex application 200 including multiple internal components 210 (e.g. software sub-applications). While four internal components 210 are illustrated, practical complex applications may include hundreds or more of internal components 210. Furthermore, while described herein as “internal components”, it is appreciated that the internal components 210 can include any software or systems integrated with the complex application 200, even when such software and systems are not specifically a part of the complex application 200. Within a complex application, some or all of the internal components can generate their own operation logs 212 with the data and format of each operation log 212 corresponding to the type of internal component 210 generating the log. The operations logs 212 include data describing the operations of the internal component 210, how the operation ended, and any errors that may have occurred during operation of the internal components 210. As the number of internal components 210 increases, the complexity increases, and the potential for conflicts between the operations of two or more internal components similarly increases.

In some examples, the logs 212 may take the form of images of errors shown within a user interface (UI), imported spreadsheet files of a database table, videos of screen recordings, text format data, or any similar log format. Alternatively these types of data may be provided as additional evidence by an operator of the complex application 200 responsive to an error occurring.

During operation of the complex application 200, a set of inputs 202 are provided to the complex application 200, the internal components 210 operate, and a set of outputs 204 is generated. An end user is generally only aware of the contents of the inputs 202 and the resulting outputs 204, without needing to have knowledge of the inner workings of the complex application 200.

When an error occurs an error notification is generated and the issues surrounding the error are investigated by reviewing the operation logs 212. This review includes substantial amounts of manual efforts to match the data between the different operation logs 212 and to consolidate the data into a meaningful, and intelligible, data set. In modern computing systems, there are too many internal components 210 for human technicians to be able to identify, review, and analyze the operations logs 212 relevant to a given error within a time frame needed to correct the error or to prevent further cascading errors. In addition, the number of internal components 210 that may have caused the error makes even identifying the relevant logs 212 to analyze difficult.

When different operations logs 212 are in the same format and include the same data elements, existing tools can provide a way to merge different operations logs 212 from different internal components 210 into a unified operations log. However, when the different internal components 210 provide different types and/or formats of the operations log 212, the existing tools cannot provide a meaningful combination of the operations log 212. In addition, further evidences (e.g. screenshots, textual descriptors, and the like) may be human generated and provide further context around the error. Existing tools are not capable of incorporating the human generated evidences. In some cases, unifying the various logs may result in a conflict due to time differences of different systems and/or time zone differences of the physical locations of the various systems from which the operations logs 212 are generated. In such instances, human generated evidences may be utilized to resolve the conflict.

Furthermore, existing tools are limited to providing a unified log including all data of all logs being combined, and do not include any assistance in analyzing the data or identifying relevant portions of the unified log. As a result, even when a unified log is present, the time required to fully review and analyze the unified log of the complex application 200 can be too long for human technician's to perform in a meaningful capacity before any identified resolution of the error is moot.

The systems described herein provide consolidated error reports (operations logs) uploaded from a user, with the consolidated error report including a consolidation of multiple distinct types and formats of logs. The systems also provide a rating of matching scores to the information contained in the consolidated error report. The matching scores ensures that the data is presented in a way that identifies the relevant data and operations that lead to the occurrence of the error, thereby ensuring that the technician does not expend substantial amount of time reviewing the logs in an attempt to identify where the error is and allowing the technician to proceed immediately to identifying why the error occurred.

In one general high level embodiment, an error diagnostics system for a complex applications systems (block 150) first identifies an actual error in the operations log 212 of the internal component 210 that experienced the error. Then, the error diagnostics system centers each of the other operations logs 212 around the identified portion of the operations log 212 containing the error, thereby establishing what each of the internal components 210 was doing shortly before, during and shortly after the error occurred. The centered operations logs are then unified with each other and with any additional evidence provided by the user encountering the error into a unified error log. The unified error log provides a focused view on the internal components 210 and times/operations most likely to have contributed to the error. The unified log is transmitted to a technician who can then analyze the data to determine the error cause(s) and possible resolutions to the error.

Turning now to an overview of specific aspects of the invention, one or more embodiments of the invention address the above-described shortcomings of the prior art by providing a data transformer that can be connected to a complex application 200. The data transformer is used to meaningfully combine the disparate operations logs 212 and collected evidence into an easily interpretable view.

When an error occurs, the end user may also collect evidence and/or documentation of the error in any form that the end user is able to collect. By way of example, documentation can include screenshots, recordings, textual descriptions of the error, timestamps, error codes, and/or any similar element visible to the end user.

The data transformer receives the error report and associates operations logs 212 and internal components 210 with the error. The data transformer then analyzes the user description and evidence and creates metadata that can be used to group operations log data streams with particular metadata. Each data stream provides different metadata based on the operations being performed by the end user.

By way of example, a product's log metadata could be: {“_account”:“xxxxx”,“_cluster”:“ld23”,“_host”:“xx.xx.xx.xx,”_ingester”:“logdna-agent/2.2.8(Ubuntu/18.04)”,“_label”:{“run_id”:“71”,“pod-template-hash”:“7df6f99”,“service_instance_id”:“696f1e7f”,“pipeline_name”:“repl-basic-ddl-1”,“account_id”:“0a68cade7dc”,“app”:“ibm-replication”,“name”:“basic-1”,“create_timestamp”:“1669764143”,“user_defined_comp_i d”:“863c9c2db941e9b”,“component”:“engine”,“job_id”:“09213390”,“project_id”: “c44da1f”},“_logtype”:“json”,“_file”:“/var/log/containers/something.log”,“_line”:“JAVA_HOME=/opt/java”,“_rawline”:null,“_ts”:16651,“_app”: “controller”,“_ip”:“150.239.171.186”,“__key”:“logline:57631-7d9b9f6f99-njsd2:ld23”,“pod”:“8-njsd2”,“namespace”:“data-rep”,“container”:“controller”,“containerid”:“5f4b596f”,“node”:“kube-51\n”,“_bid”:“fc:l d23”,“JAVA_HOME”:“/opt/java”,“_id”:“15531”}

The data transformer collects properties from the metadata and identifies values of those properties in the descriptions and evidence provided by the end user.

The data transformer merges operations logs from various internal components 210 around that operation being used by the end user. These properties can be nested and have different scores, with the score corresponding to how relevant the properties are to the error being investigated. The data transformer provides a view of the logs with a highest score view to a technician who can then analyze the relevant data.

In one example, the data transformer provides matching exact timestamps with a given score and matching exact hosts with another score. As the time stamp in an operations log deviates from the exact time stamp (either forward or backwards) the given score for the timestamp reduces, with the further the timestamp is from the time of the error the lower the score. Similarly, as the type of internal component deviates from the type of internal component including the error the score is reduced. This merging process provides a general score for each operations log 212 with areas of the operations logs 212 having the highest score being those most expected to be relevant.

When the merging process provides a conflict (e.g. where the merging process could apply distinct scores to a single element) the system can provide one of two solutions. In a manual solution, the technician reviews the conflict and confirms which score should be applied. In an automatic process, the system proceeds by applying both scores and presenting the technician with an end view that includes both possible options.

With continued reference to FIGS. 1 and 2, FIG. 3 illustrates an exemplary flow 300. Initially, an end user 302 encounters an error. The end user 302 raises a product issue by creating a tracking ticket 304 in an error reporting system. The error reporting system identifies all related data (e.g. all operations logs 212 of internal components 210 that are related to the operation encountering the error) and dumps all the identified operations logs into a data sets 306. Any evidence and data provided by the end user 302 is added to the data set 306.

The data set 306 is then provided to the data transformer 308, which performs a merge and identifies the most relevant data 316 from the merged logs 212 and evidence provided by the end user 302. The identified relevant data is then provided to a technician 312.

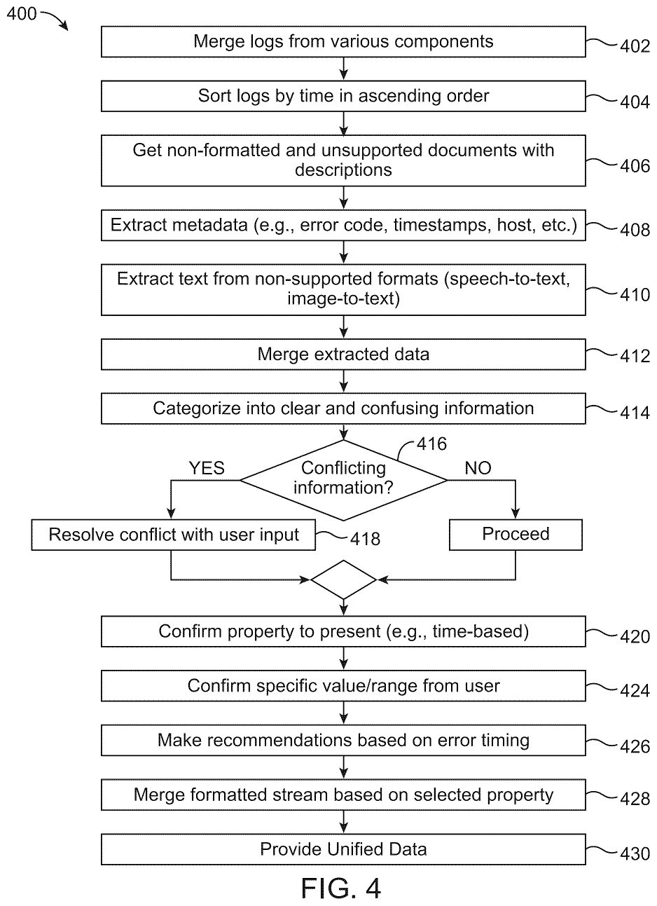

With continued reference to FIGS. 1-3, FIG. 4 illustrates one specific example merge process 400 employed by a data transformer 308. Initially all the logs 212 are gathered and merged in a merge step 402 and sorted based on timestamps in ascending order in a sort step 404. The logs 212 may be merged in any order. Once merged, the data transformer 308 obtains all non-formatted and unsupported documents (e.g. evidence and descriptions provided by the end user 302) in a gather evidence step 406.

The data transformer 308 then extracts metadata information collected from the merged log files and from keywords identified in any descriptions provided by the end user 302 in a meta data extraction step 408. The metadata extraction includes keywords, error codes, all possible time stamps, host, application name, component names, and any similar data. The metadata is extracted in a predefined scripted order in order to prevent conflicts.

After extracting metadata from the collected information, text is extracted from non-text data formats in an extract text step 410. By way of example, non-text data formats can include audio tracks, image files including text, video files including text, or any similar file type that may include information. The text can be extracted using any conventional extraction process (e.g., optical character recognition, speech to text software, closed caption generators, or any similar extraction process).

The metadata information and the text data is merged together in a merge extracted data step 412, and categorized into sets of clear data and unclear data in a categorization step 414.

The process 400 then determines if any of the merged extracted data conflicts in a conflicting data check 416. When conflicting data is present the process 400 provides a prompt to the user 302, allowing the user to correct the conflict in a resolve conflict step 418. When there is no conflicting data, or after the conflict has been resolved, the process 400 confirms from the user 302 which metadata property the end view should be centered on in a confirm property step 420. The metadata properties can be structured when the metadata originates from software component and describes circumstances at the time the error occurred. In such cases, the metadata can contain a component Id, a thread Id, a Host id, a class the software is currently executing, specific methods inside the class that is getting executed, specific messages corresponding to the error, and unique identifier to distinguish between two instances of same application logged in the same log file. In some examples, the metadata may also be unstructured evidence unrelated to the specific timing of the error. In such examples, the unstructured metadata can include a host, a time of capturing evidence vs time of the error in the evidence, and results of processing any provided evidence. In some examples, the user 302 may select multiple properties instead of just a single property.

After selecting the desired properties to center the view on, the user 302 provides a value range in a confirm value/range step 424. The value/range defines a specific value and provides a window of plus/minus data entries above and below the value to include within the view.

In some examples, the process 400 may automatically provide recommendations and/or respond to the provided value with a recommendation of relevant values and windows in a recommendation step 426. By way of example, when the value selected is an error type, the recommendation may be a window of timestamps at +/−0.5 seconds from the occurrence of the error type.

After centering the data on the selected values and ranges, a final merge occurs and all the data sources are merged into a unified data set in a create unified data step 428, and the unified data is provided to the technician in a provide unified data step 430.

Referring collectively to FIGS. 1-4, In one example implementation a user 302 describes a problem that is currently occurring. By way of example, the problem may be a hung state situation in a software product (the complex application 200) with no easily interpretable sign of the specific error. The user 302 uploads all the evidences and describes what is observed using images, text and logs.

Based on the title of the user's upload, the system determines a nature of the problem (hung state) and attempts to identify information about the problem within the uploaded evidence. By way of example, the system may attempt to identify the time, or time range, in which the problem occurred, which internal component was running when the problem occurred, and which internal components may include corresponding error text in its log 212. This is determined via an automatic analysis of the log entries.

The automatic analysis is then refined and validated using attached evidence (e.g. non-log format files) including images videos, screenshots, charts, etc. The user 302 is asked to confirm identified conflicts and/or time ranges before the process 400 proceeds. If no confirmation is provided within a default time period the selection may be automated with a feature that allows the confirmation to be later adjusted.

After the initial refining, any other formatted data or streamed log sources is searched for portions matching the identified conflicts and/or time ranges and consolidated into a unified view. The unified view is provided to the technician who then analyzes the information and identifies a root cause, or potential root cause, of the problem.

In the event that more information is needed, the technician 312 may use the ticketing system to request additional information, local logs, or any other needed information from the end user 302.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
identifying an occurrence of an error within a complex application, wherein the complex application includes a plurality of internal components;
gathering a plurality of operation logs into a log set, each operation log in the plurality of operation logs being generated by a corresponding one of the plurality of internal components, and wherein at least one of a format and a type of operation log is not uniform across the plurality of operation logs;
applying the log set to a data transformer, the data transformer being a software module configured to merge the operation logs into a merged log and identify relevant data of the merged log; and
providing the identified relevant data of the merged log to a technician.

2. The computer-implemented method of claim 1, wherein the plurality of internal components includes multiple distinct internal components types, and wherein the plurality of operation logs include a plurality of data types.

3. The computer-implemented method of claim 1, wherein gathering the plurality of operation logs into the log set further includes gathering at least one of a screenshot, a recording, a textual description of the error, a timestamp of the error, and an error code as additional data and incorporating the additional data into the log set.

4. The computer-implemented method of claim 1, wherein the data transformer sorts data in the log set by time in ascending order and extracts metadata from the operations logs in the log set.

5. The computer-implemented method of claim 4, wherein extracting metadata from the operations logs in the log set includes extracting predefined meta data and identifying metadata keywords in an addition data portion of the log set.

6. The computer-implemented method of claim 5, wherein metadata is extracted in a scripted predefined order.

7. The computer-implemented method of claim 6, further comprising extracting text from at least one non-text format data of the operations logs in the log set and the additional data in the log set and merging the extracted meta data and the extracted text data into a merged log set.

8. The computer-implemented method of claim 1, further comprising categorizing, by the data transformer, each data element of the merged log set into one of a clearly related to an error data category, a clearly unrelated to the error data category, and an unclear data category.

9. The computer-implemented method of claim 8, further comprising wherein the data transformer is configured to identify a timestamp of the error and center each operation log in the plurality of operation logs on the timestamp.

10. The computer-implemented method of claim 9, where the data transformer applies a score to each entry in each operation log, with a value of the score being decreased by a deviation of the entry from the timestamp of the error, and wherein the error data category is determined at least in part by the score.

11. The computer-implemented method of claim 1, wherein each internal component has a type, and wherein the value of the score is further decreased by a value representative of a difference in types between the internal component type of the operation log containing the error and the internal component type of the operation log.

12. A computer program product storing instructions configured to cause a computer to perform operations including:
identifying an occurrence of an error within a complex application, wherein the complex application includes a plurality of internal components;
gathering a plurality of operation logs into a log set, each operation log in the plurality of operation logs being generated by a corresponding one of the plurality of internal components, and wherein at least one of a format and a type of operation log is not uniform across the plurality of operation logs;
applying the log set to a data transformer, the data transformer being a software module configured to merge the operation logs into a merged log and identify relevant data of the merged log; and
providing the identified relevant data of the merged log to a technician.

13. The non transitory computer readable medium of claim 12, wherein the plurality of internal components includes multiple distinct internal components types, and wherein the plurality of operation logs include a plurality of data types.

14. The non transitory computer readable medium of claim 12, wherein gathering the plurality of operation logs into the log set further includes gathering at least one of a screenshot, a recording, a textual description of the error, a timestamp of the error, and an error code as additional data and incorporating the additional data into the log set.

15. The non transitory computer readable medium of claim 12, wherein the data transformer sorts data in the log set by time in ascending order and extracts metadata from the operations logs in the log set.

16. The non transitory computer readable medium of claim 15, wherein extracting metadata from the operations logs in the log set includes extracting predefined meta data and identifying metadata keywords in an addition data portion of the log set, wherein metadata is extracted in a scripted predefined order.

17. The non transitory computer readable medium of claim 16, further comprising extracting text from at least one non-text format data of the operations logs in the log set and the additional data in the log set and merging the extracted meta data and the extracted text data into a merged log set.

18. The non transitory computer readable medium of claim 12, further comprising categorizing, by the data transformer, each data element of the merged log set into one of a clearly related to an error data category, a clearly unrelated to the error data category, and an unclear data category.

19. The non transitory computer readable medium of claim 12, further comprising wherein the data transformer is configured to identify a timestamp of the error and center each operation log in the plurality of operation logs on the timestamp.

20. A system comprising:
a computer including a processor set and persistent storage, the persistent storage storing instructions for causing the processor set to perform operations including:
identifying an occurrence of an error within a complex application, wherein the complex application includes a plurality of internal components;
gathering a plurality of operation logs into a log set, each operation log in the plurality of operation logs being generated by a corresponding one of the plurality of internal components, and wherein at least one of a format and a type of operation log is not uniform across the plurality of operation logs;
applying the log set to a data transformer, the data transformer being a software module configured to merge the operation logs into a merged log and identify relevant data of the merged log; and
providing the identified relevant data of the merged log to a technician.
